(19) United States
(12) Patent Application Publication
(10) Pub. No.: US 2008/0073055 A1
(43) Pub. Date: Mar. 27, 2008

(54) SPLIT ACCESS FAN SHROUD

(75) Inventors: Steven W. Inniger, Hoagland, IN (US); Steven P. Kuhn, Fort Wayne, IN (US); George A. Brown, Milford, MI (US); Gary Falendysz, Racine, WI (US); Daniel Voisin, Racine, WI (US); James Vaughn, Cudahy, WI (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/952,710

(22) Filed: Dec. 7, 2007

Related U.S. Application Data
(62) Division of application No. 10/968,533, filed on Oct. 19, 2004.

(51) Int. Cl. B60R 27/00; B60H 1/00

(52) U.S. Cl. 165/41

(57) ABSTRACT

A fan shroud for a mobile vehicle having an opening therein for the easy removal of the cooling fan therethrough. A removable shroud section is provided in various embodiments, exemplifying efficient modes of manufacture for said removable shroud section and its attachment to said fan shroud.

### BACKGROUND OF THE INVENTION

This invention relates to a radiator shroud with a removable shroud section that provides for easy removal of the cooling fan from a mobile vehicle. Specifically, multiple embodiments are disclosed by means of which a shroud with a removable shroud section may be readily and inexpensively manufactured and incorporated into a mobile vehicle.

### SUMMARY

Mobile vehicles, especially heavy-duty commercial vehicles, are commonly configured with the engine located longitudinally forward of the cab and mounted to a set of frame rails, which form the structure of the vehicle. Forward of the engine is a radiator or heat exchanger, which serves to reject waste heat created by the engine in powering the vehicle. This area of the engine compartment is often tightly packed with engine and vehicle accessories and subsystems, such as fluid and air conduits, pumps, reservoirs, generators, and other devices. In the center of all of this hardware is the engine cooling fan, which is located between the engine and the radiator. It is driven by the accessory belt or Front of Engine Accessory Drive (FEAD) and is mounted on a fan drive, which often provides a clutched or viscous link to the engine rotation. In order to improve the cooling performance of the engine cooling fan and radiator, a shroud is also provided. This shroud forces cooling air to pass through the radiator before passing through the cooling fan, and prevents recirculating air from hindering the performance of the cooling system.

In the case of previous engine cooling system shrouds, the same barrier that the shroud presented to recirculating air, also became a barrier to removing the engine cooling fan from the fan drive. As a result, the shroud presented a barrier to servicing the fan drive itself, the FEAD and its belt, and any of a number of other engine accessory devices that may have been located in this area.

Previous to the invention disclosed herein, a mechanic or service technician who needed to remove the engine cooling fan in order to perform maintenance upon one of these obscured devices was required to unbolt the entire shroud from the radiator. He or she would then remove any devices external to the shroud that prevented it from translating rearward, which often involved disconnecting several devices and even draining engine cooling and hydraulic systems. Once this was done, the technician would translate the shroud rearward, thereby exposing the front of the fan and its attachment to the fan drive. The next step was to remove the fan, and then translate the shroud forward and support it temporarily, so that it would not bear against the front of the engine nor prevent access thereto. Once the desired maintenance was complete, the entire process would be reversed. The shroud often presented an obstacle to serviceability in this way.

The invention disclosed herein provides a path of removal of the engine cooling fan without requiring the unbolting and removal of the entire shroud, while retaining the benefit of the shroud and its ability to prevent recirculation of cooling air. The invention includes a shroud with a removable shroud section large enough for passage of the cooling fan. Multiple embodiments are presented, particularly those which provide an effective and inexpensive way to affix the removable shroud section to the shroud, yet retain it securely during vehicle operation, and allow it to be readily removed to provide access. Several of these embodiments do not require the use of tools.

The figures listed illustrate a removable shroud section that is either completely removable, hinged on one end, slidably affixed to the shroud, or rotatable around a point on an axis perpendicular to that of the cooling fan. The removable shroud section may be hinged towards the front of the vehicle, hinged at the opposite end as that shown, or provided in any of a multitude of arrangements which would allow it to move out of the path of removal of the engine cooling fan.

The invention as presented is a solution to one of the maintenance difficulties heretofore inherent in the design of cooling systems for mobile vehicles with longitudinally mounted engines and engine-driven fan cooled radiators. It is inexpensive to implement and has the potential to save a tremendous amount of time and resources in the maintenance of mobile vehicles, especially for commercial vehicles.

### DRAWINGS

FIG. 1—A rear view of a vehicle made in accordance with a first embodiment of the invention.

FIG. 2—A rear view of a vehicle made in accordance with a second embodiment of the invention.

FIG. 3—A rear view of a vehicle made in accordance with a third embodiment of the invention.

FIG. 4—A rear view of a vehicle made in accordance with a fourth embodiment of the invention.

FIG. 5—A rear view of a vehicle made in accordance with a fifth embodiment of the invention.

FIG. 6—A rear view of a vehicle made in accordance with a sixth embodiment of the invention.

FIG. 7—A detailed view of the removable shroud section in a hinged embodiment and utilizing an integrated snap-in tab.

FIG. 8—A detailed view of the removable shroud section in a hinged embodiment and utilizing snap fasteners.

FIG. 9—A detailed view of the removable shroud section in a hinged embodiment and utilizing twist-lock fasteners.

FIG. 10—A detailed view of the removable shroud section in a hinged embodiment and utilizing conventional fasteners.

FIG. 11—A detailed view of the removable shroud section in a hinged embodiment and utilizing a formed hinge.

FIG. 12—A detailed view of the removable shroud section in a hinged embodiment and utilizing a living hinge.

FIG. 13—A detailed view of the removable shroud section in a completely removable embodiment and utilizing integrated snap-in tabs.

FIG. 14—A detailed view of the removable shroud section in a completely removable embodiment and utilizing snap fasteners.

FIG. 15—A detailed view of the removable shroud section in a completely removable embodiment and utilizing twist-lock fasteners.

FIG. 16—A detailed view of the removable shroud section in a completely removable embodiment and utilizing conventional fasteners.

### DETAILED DESCRIPTION

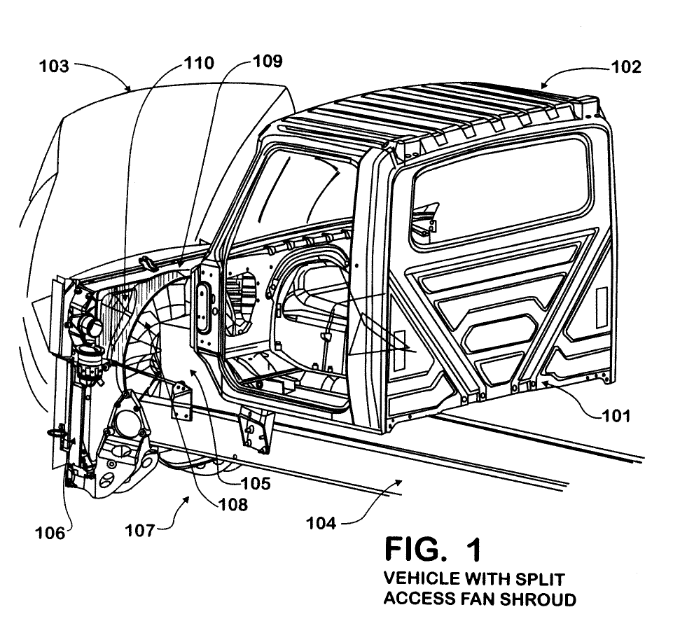

The vehicle 101 shown in FIG. 1 has a cab 102 and a hood 103 engaged to a chassis 104. The chassis 104 has an engine 105, which provides power for propulsion of vehicle 101, and in so doing creates waste heat. The chassis 104 also has a radiator 106, located forward of engine 105, relative to vehicle 101 forward movement, which serves to reject said heat to the surrounding environment 107. Attached to and driven by engine 105 in a conventional manner is fan 108, which serves to increase heat transfer from radiator 106 to the surrounding environment 107, by increasing airflow through radiator 106 when vehicle 101 is slowed or stopped. The fan 108 may be driven either directly or indirectly by the engine 105. The radiator 106 has a shroud 109, which channels said airflow through fan 108 in a conventional manner, and prevents recirculation thereof, thereby increasing the operating efficiency of radiator 106. In accordance with the invention disclosed herein, shroud 109 is provided with a removable shroud section 110, which is shown in its installed position.

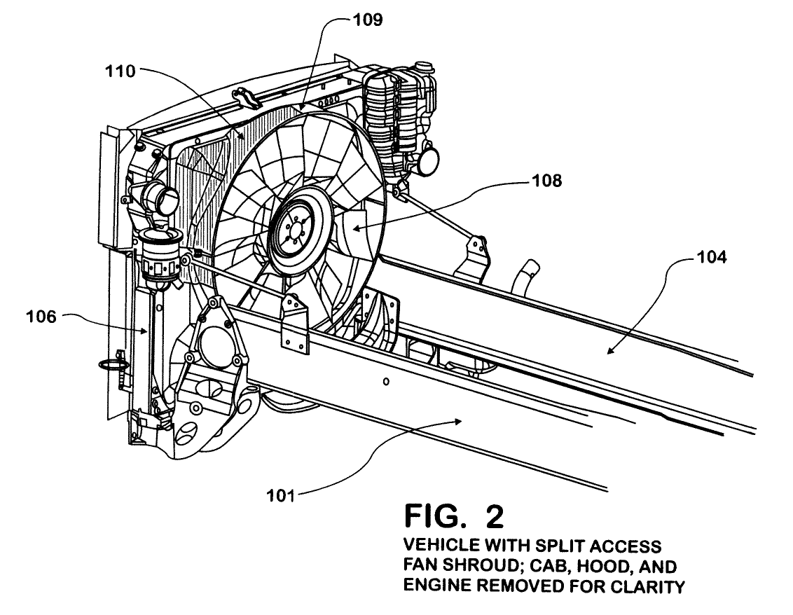

The vehicle 101 shown in FIG. 2 has a similar chassis 104, radiator 106, fan 108, shroud 109, and removable shroud section 110, as the vehicle 101 shown in FIG. 1. For the sake of clarity, cab 102, hood 103, and engine 105 are not shown in FIG. 2. Fan 108 is shown in its installed location. Removable shroud section 110 also is shown in its installed location.

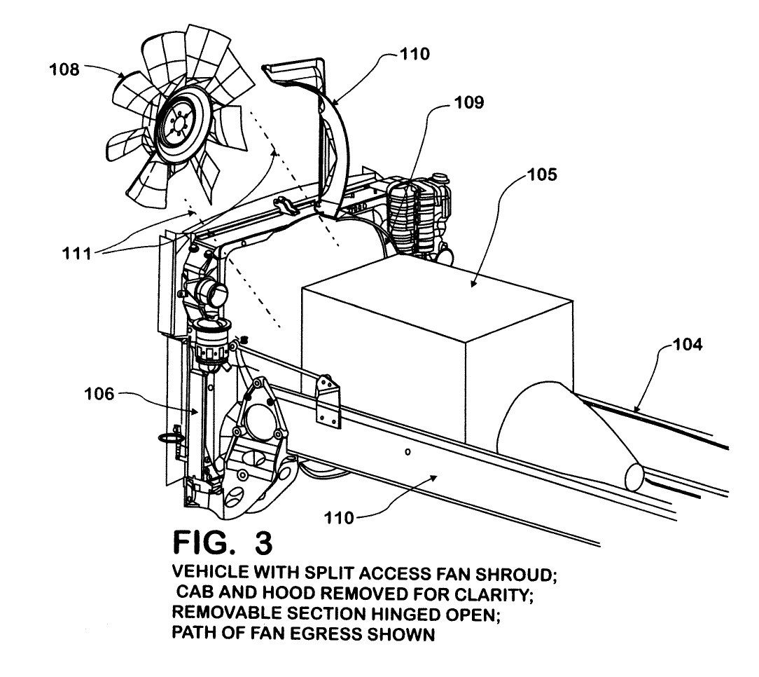

The vehicle 101 shown in FIG. 3 has a similar chassis 104, engine 105, radiator 106, fan 108, shroud 109, and removable shroud section 110, as the vehicle 101 shown in FIG. 1. For clarity, cab 102 and hood 103 are not shown in FIG. 3. Removable shroud section 110 is shown in a hinged embodiment, and is shown in the open position. Fan 108 is shown in a location along path of removal projection lines 111. In this way, the advantageous nature of shroud 109 having removable shroud section 110, specifically by providing a path of removal of fan 108 without necessitating the removal of shroud 109, is taught.

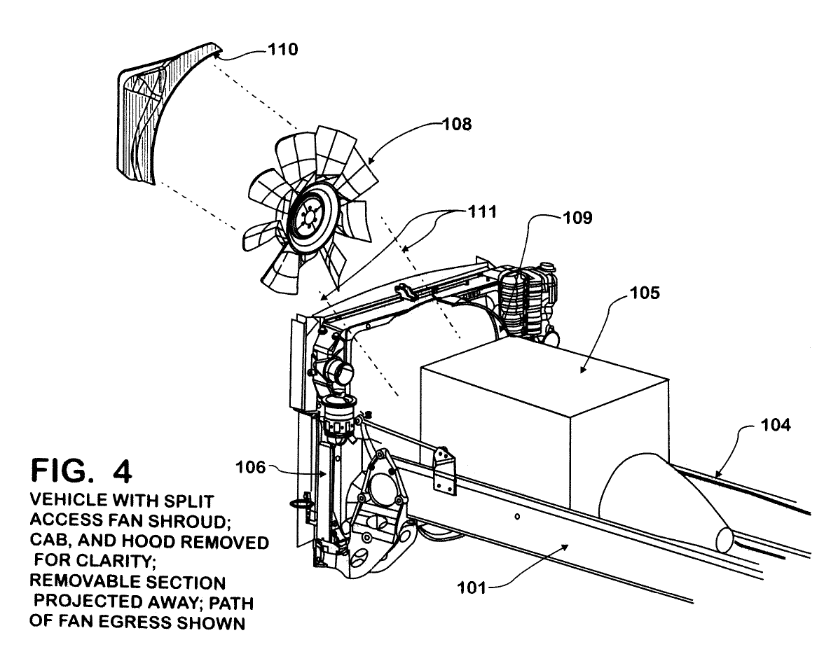

The vehicle 101 shown in FIG. 4 has a similar chassis 104, engine 105, radiator 106, fan 108, shroud 109, and removable shroud section 110, as the vehicle 101 shown in FIG. 3. Again for clarity, cab 102 and hood 103 are not shown in FIG. 4. Removable shroud section 10 is shown in a completely removable embodiment, and is shown projected from its installed location. Fan 108 is shown in a location along path of removal projection lines 111, similarly showing the method by which it can more simply be removed from engine 105.

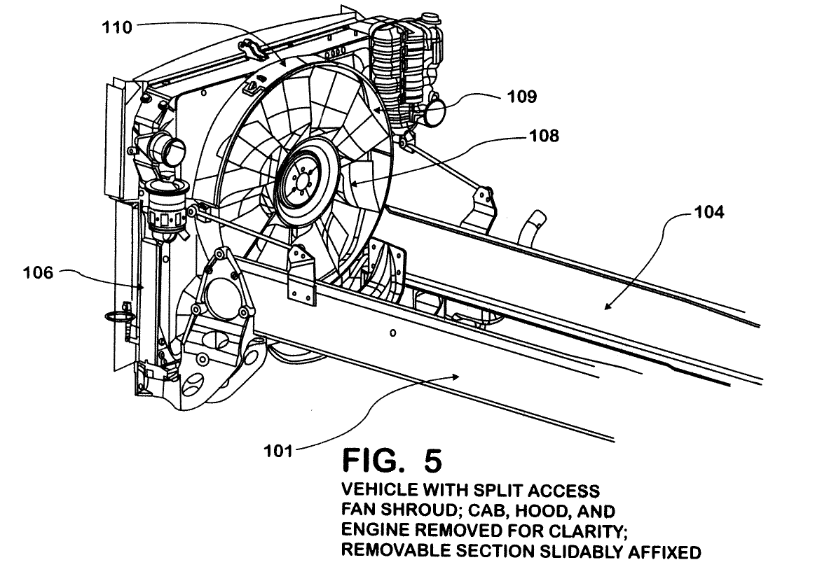

The vehicle 101 shown in FIG. 5 has a similar chassis 104, radiator 106, fan 108, shroud 109, and removable shroud section 110, as the vehicle 101 shown in FIG. 2. For clarity, cab 102, hood 103, and engine 105 are not shown in FIG. 5. Removable shroud section 110 is shown in a slidable embodiment, and is shown in a half-open position for the sake of illustration.

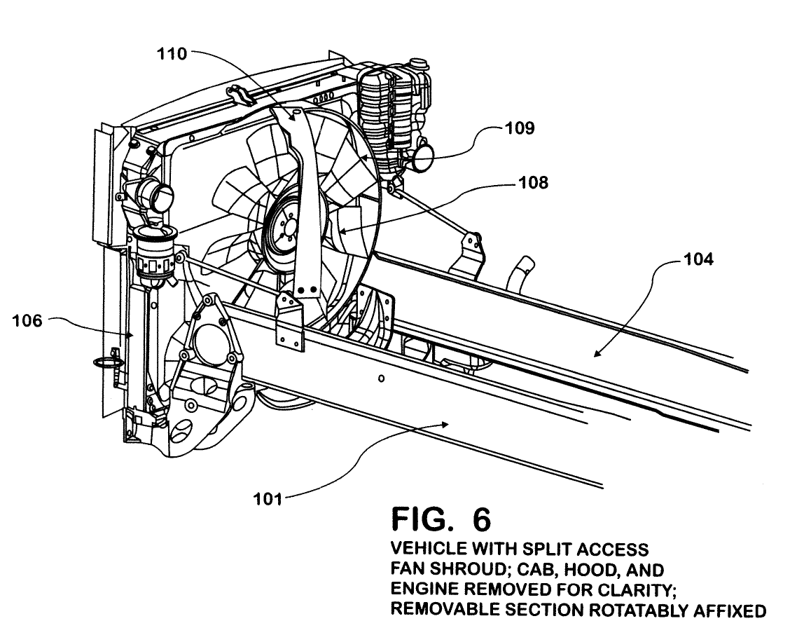

The vehicle 101 shown in FIG. 6 has a similar chassis 104, radiator 106, fan 108, shroud 109, and removable shroud section 110, as the vehicle 101 shown in FIG. 2. For clarity, cab 102, hood 103, and engine 105 are not shown in FIG. 6. Removable shroud section 110 is shown in a rotatable embodiment, and is shown in the open position.

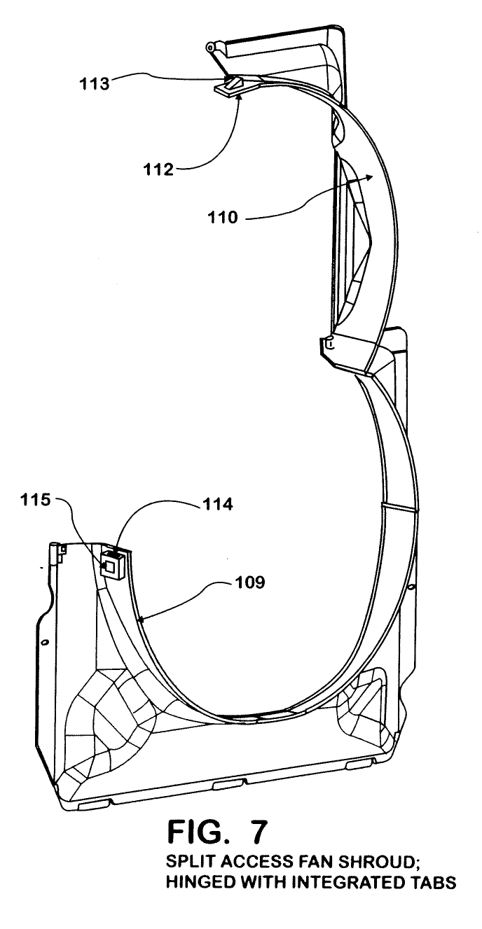

FIG. 7 is a detailed view showing shroud 109 and removable shroud section 110 in a hinged embodiment. Removable shroud section 110 is provided with one or more tangs 112, which in turn have catches 113. Shroud 109 is provided with the same number of slots 114, which each have a recess 115. Catch 113 projects into recess 115 when tang 112 is inserted into slot 114, thereby providing secure attachment of removable shroud section 110 to shroud 109.

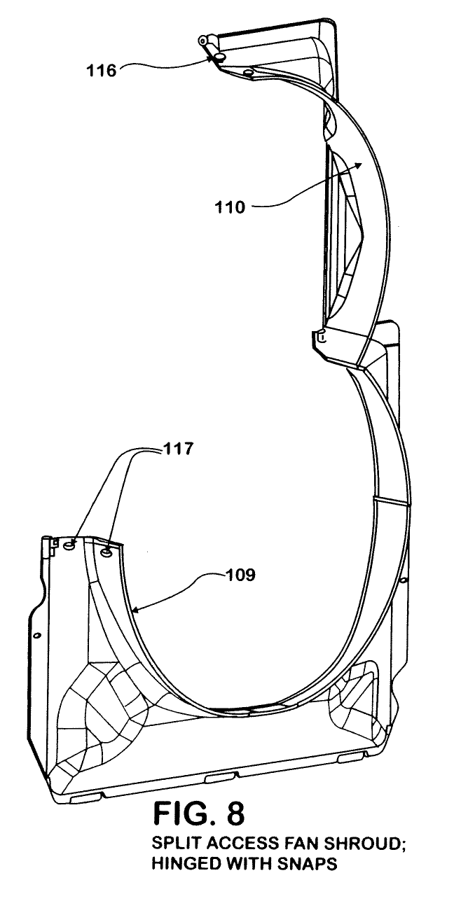

FIG. 8 is a detailed view showing shroud 109 and removable shroud section 110 in a hinged embodiment. Removable shroud section 110 is provided with one or more conventional snap devices 116. Shroud 109 is also provided with the same number of compatible snap features 117. In this way, removable shroud section 110 may be retained in the closed position.

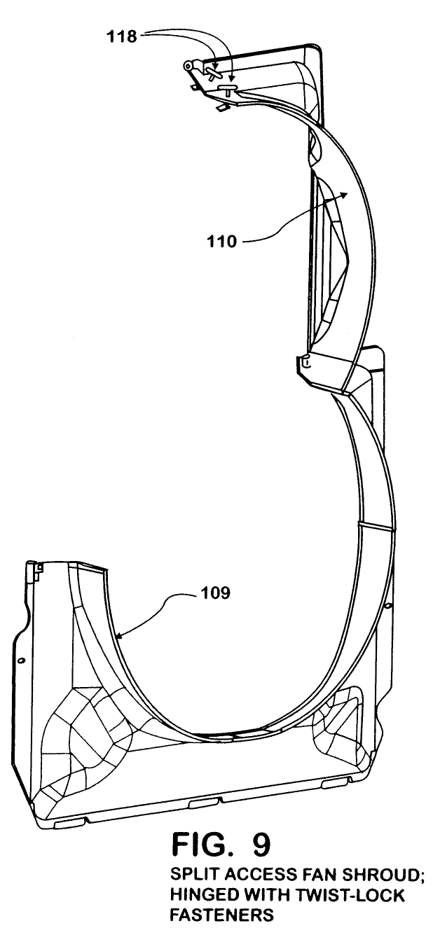

FIG. 9 is a detailed view showing shroud 109 and removable shroud section 110 in a hinged embodiment. Removable shroud section 10 is provided with one or more common twist-lock fasteners 118 or their equivalent. Twist-lock fasteners 118 may be engaged to shroud 109 when removable shroud section 110 is in the closed position, thereby retaining removable shroud section 110 in the closed position.

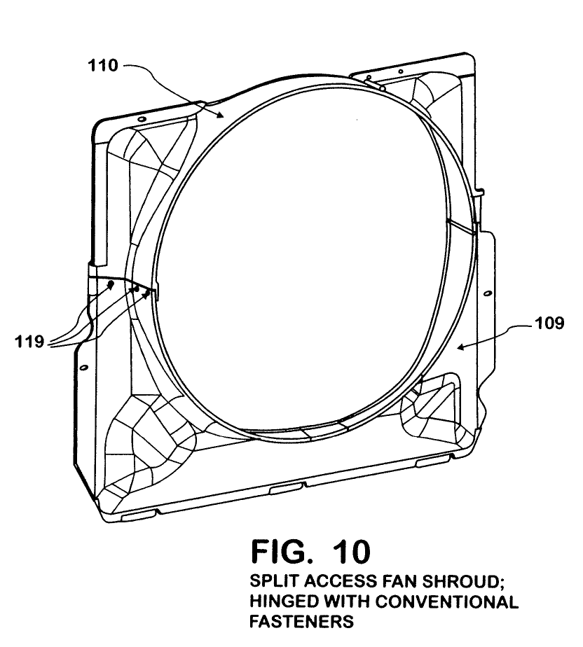

FIG. 10 is a detailed view showing shroud 109 and removable shroud section 110 in a hinged embodiment. Removable shroud section 110 is retained in the closed position by means of conventional fasteners 119. Opening removable shroud section 110, therefore, requires removable of conventional fasteners 119.

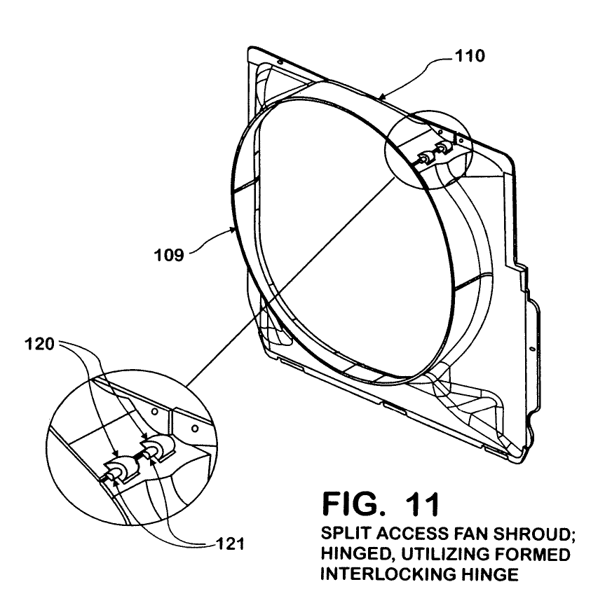

FIG. 11 is a detailed view showing shroud 109 and removable shroud section 110 in a hinged embodiment. Removable shroud section 110 is provided with a conventional formed interlocking hinge 120. Shroud 109 is provided with a compatible formed hinge retainer 121. The formed interlocking hinge 120 of removable shroud section 110 fits onto the compatible formed hinge retainer 121 of shroud 109, thereby providing an inexpensive hinging mechanism.

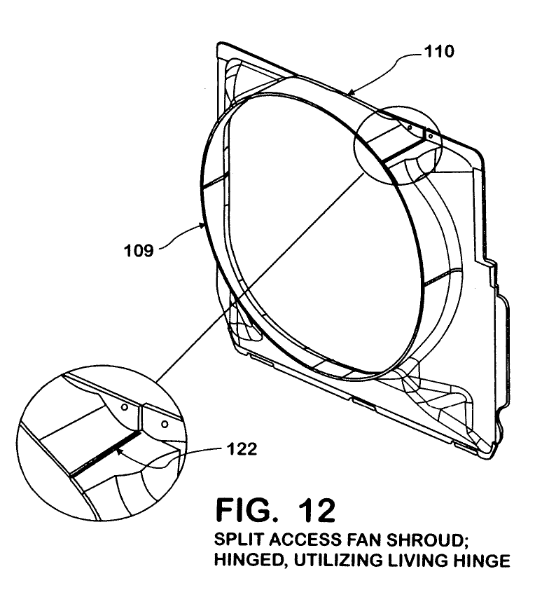

FIG. 12 is a detailed view showing shroud 109 and removable shroud section 110 in a hinged embodiment. Removable shroud section 110 is attached directly to shroud 109 by means of a living hinge 122. Specifically, a living hinge is a conventional means whereby localized deformation of a thin and resilient plastic along a line of bending provides an inexpensive hinging mechanism.

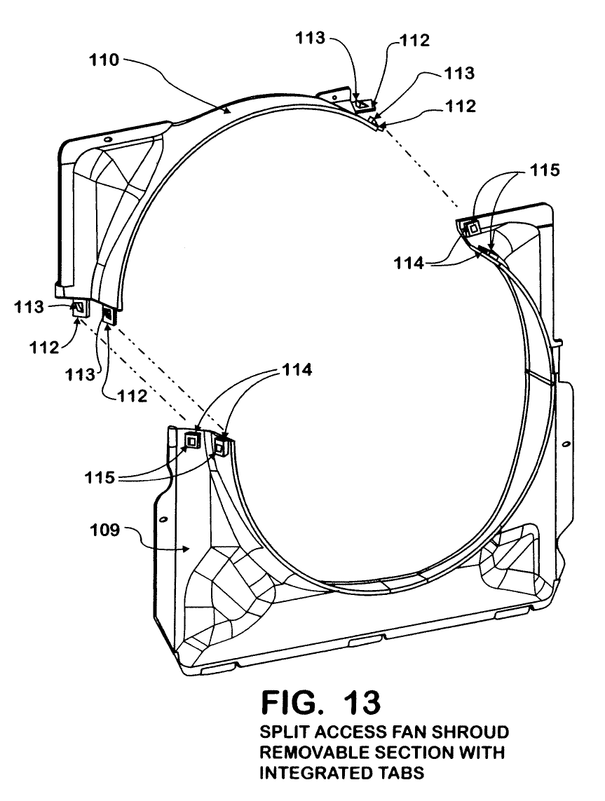

FIG. 13 is a detailed view showing shroud 109 and removable shroud section 110 in a completely removable embodiment. Similar to FIG. 7, removable shroud section 110 is provided with one or more tangs 112, which in turn have catches 113. Shroud 109 is provided with the same number of slots 114, which each have a recess 115. Again, catch 113 projects into recess 115 when tang 112 is inserted into slot 114, thereby providing secure attachment of removable shroud section 110 to shroud 109.

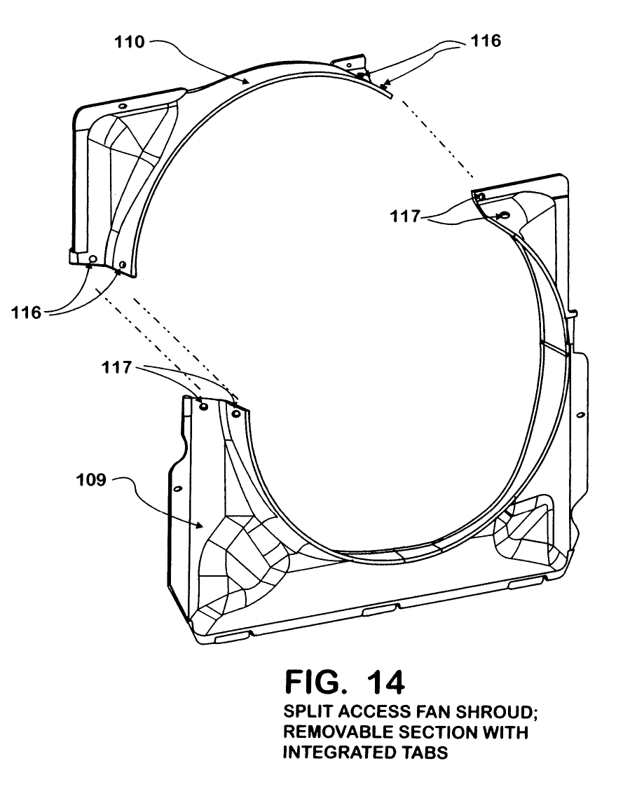

FIG. 14 is a detailed view showing shroud 109 and removable shroud section 110 in a completely removable embodiment. Similar to FIG. 8, removable shroud section 110 is provided with one or more conventional snap devices 116. Shroud 109 is also provided with the same number of compatible snap features 117. Again, removable shroud section 110 is affixed to shroud 109 by means of snap devices 116 and 117.

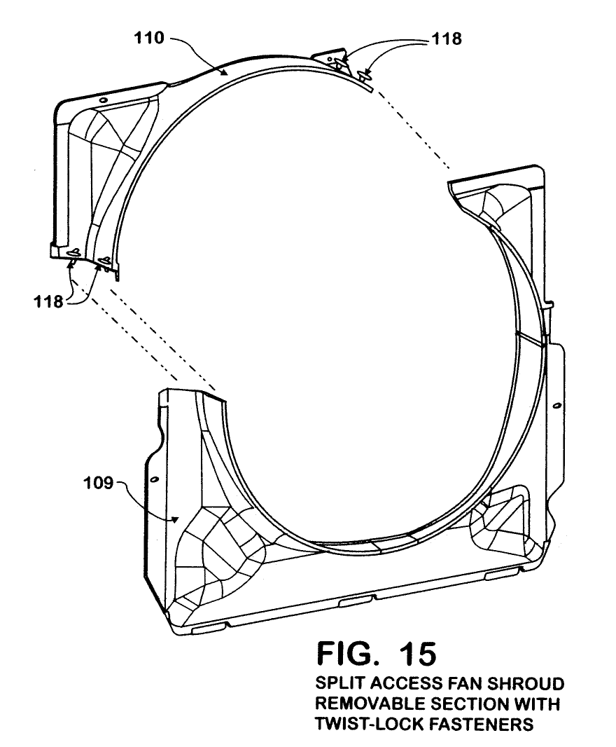

FIG. 15 is a detailed view showing shroud 109 and removable shroud section 110 in a completely removable embodiment. Similar to FIG. 9, removable shroud section 110 is provided with one or more common twist-lock fasteners 118 or their equivalent, which may be engaged to shroud 109, thereby affixing removable shroud section 110 to shroud 109.

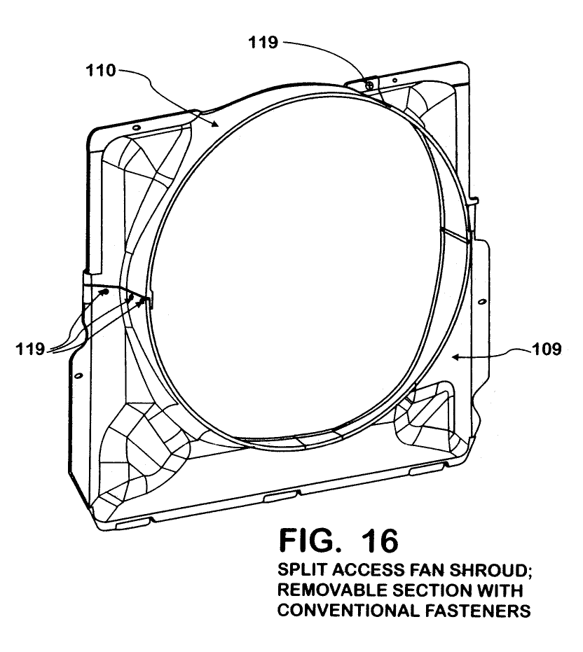

FIG. 16 is a detailed view showing shroud 109 and removable shroud section 110 in a completely removable embodiment. Similar to FIG. 10, removable shroud section 110 is affixed to shroud 109 by means conventional fasteners 119. Removing removable shroud section 110, therefore, requires removal of conventional fasteners 119.

Other permutations of the invention are possible without departing from the teachings disclosed herein, provided that the function of the relationship of the removable shroud section 110 is to provide a path of removal of fan 108 without necessitating removal of shroud 109. Other advantages to a vehicle 101 equipped with a shroud 109 having a removable shroud section 110 may also be inherent in the invention, without having been described above.

1. (canceled)

2. A mobile vehicle for operation on the ground, comprising:
an engine attached to a chassis;
a heat exchanger attached to said chassis and located forward of said engine relative to said mobile vehicle forward movement;
a cooling fan driven by said engine, and located between said engine and said heat exchanger;
a shroud located between said heat exchanger and said engine, enveloping said fan and providing for increased airflow through said heat exchanger;
an opening in said shroud at a point approximately perpendicular to the axis of rotation of said fan, said opening being sufficiently large for passage of said fan therethrough; and
a removable shroud section affixed to said shroud over said opening;
said removable shroud section being attached to said shroud by a hinge.

3. The vehicle of claim 2, wherein:
said hinge further comprises an interlocking hinge mechanism integrally formed into said removable shroud section; and
a formed hinge retainer integrally formed into said shroud and compatible with said interlocking hinge mechanism integrally formed into said removable shroud section.

4. The vehicle of claim 2, wherein:
said hinge between said removable shroud section and said shroud further comprises a living hinge.

5. The vehicle of claim 2, wherein:
said removable shroud section being provided with a fastener for securely engaging said removable shroud section to said shroud.

6. The vehicle of claim 5, wherein:
said fastener further comprises one or more tangs attached to said removable shroud section, each of said tangs having a catch; and
one or more slots formed into said shroud, for insertion of said tangs therein, each of said slots having a recess for said catch.

7-28. (canceled)
